(19) United States
(12) Patent Application Publication
(10) Pub. No.: US 2026/0299971 A1
(43) Pub. Date: Oct. 1, 2026

(54) USING MACHINE-LEARNING MODELS TO GENERATE ADAPTIVE USER INTERFACES FOR ATTRIBUTE SELECTION AND ITEM REPLACEMENT SELECTION

(71) Applicant: Maplebear Inc., San Francisco, CA (US)

(72) Inventors: Ahsaas Bajaj, Jersey City, NJ (US); Katherine Tsen, New York, NY (US); Hannah Gardner, Toronto (CA); Shishir Kumar Prasad, San Ramon, CA (US); Prakash Putta, Seattle, WA (US); Alysia Echevarria, New York, NY (US); Christopher Billman, Chicago, IL (US)

(21) Appl. No.: 19/093,114

(22) Filed: Mar. 27, 2025

(51) Int. Cl. G06F 9/451; G06N 20/00; G06Q 30/0601

(52) U.S. Cl. CPC G06F 9/451; G06N 20/00; G06Q 30/0641

(57) ABSTRACT

An online system presented herein generates adaptive and personalized user interfaces for attribute selection and item replacement selection. The online system fulfills an order by picking items at a source and delivering the items to a user. When an item is not found at the source, a picker attempts to find a suitable replacement item. To find acceptable replacements, the online system allows the user, when placing an order, to specify attributes of an item that are important for that order. To provide an improved user interface that helps the user select attributes for a given item, the online system selects a subset of the item's attributes that are likely important and relevant to potential replacements. If the item is not found, the user's attribute selection is communicated to the picker, as well as used to determine and rank replacements for displaying at a user interface of a picker's device.

### BACKGROUND

Online systems allow their users to interact with items, e.g., by placing online orders for the items. A picker associated with an online system is typically dispatched to a source location (e.g., retail store) to pick items from the source location and fulfill an online order placed by a user of the online system. When the online system cannot fulfill an item in the order, the online system and the picker try to find a replacement. But users of the online system can have different preferences for attributes of different items, which can change from one order to another. For example, for one order, the user may prefer healthy snacks because they are for a child's lunch, but for another order the same user may prefer sweeter snacks because they are for a party.

However, there is currently no good way for users to specify their preferences for item attributes in a user interface of the online system. Each item typically has plenty of attributes and would be infeasible to display them all at the user interface. For example, an area of the user interface (e.g., screen space) is limited, so the item attributes would not all fit. And even if the online system could fit them all (e.g., by scrolling through the user interface), the user interface would be so cluttered and noisy, so that the user interface would be difficult to use, e.g., to find the user's desired attribute(s).

### SUMMARY

Some example embodiments of the present disclosure are directed to using machine-learning models to generate adaptive and personalized user interfaces of an online system for attribute selection and item replacement selection. The machine-learning models presented herein solve a technical problem of providing improved user interfaces displayed on displays with limited screen spaces. A user interface of a device associated with a user displays a subset of item attributes inferred by a first machine-learning model that represent a list of user's preferred attributes. A user interface of a device associated with a picker displays a subset of possible replacements inferred by a second machine-learning model based on the user's explicit selection of attributes at the user interface of the device associated with the user.

In accordance with one or more aspects of the disclosure, the online system receives, via a network and from the device associated with a user of the online system, an item request signal indicating that the user added an item to an order. Responsive to receiving the item request signal, the online system obtains a set of candidate attributes for the item. The online system applies a model to generate an attribute score for each candidate attribute from the set of candidate attributes that is indicative of an incremental change of a metric that indicates a success of the order caused by each candidate attribute. The online system selects, using the attribute score for each candidate attribute, a set of attributes from the set of candidate attributes. The online system generates, using information about the set of attributes, a first user interface signal for the device associated with the user having a first user interface with a limited display area, wherein the generating comprises displaying selectable user interface elements within the limited display area corresponding to each of the set of attributes. The online system sends, via the network, the first user interface signal to the device associated with the user, wherein the sending the first user interface signal causes the device associated with the user to display the first user interface with the limited display area that displays the selectable user interface elements corresponding to each of the set of attributes. The online system receives, via the network and from the device associated with the user, an attribute selection signal with information about a selection of one or more attributes from the set of attributes using one or more of the selectable user interface elements. The online system sends, via the network to a device associated with a picker, the attribute selection signal, wherein the sending the attribute selection signal causes the device associated with the picker to display a second user interface with the one or more attributes.

Furthermore, the online system receives, via the network and from the device associated with the picker, a missing item signal indicating that the item is not available at a source. Responsive to receiving the missing item signal, the online system retrieves, using information about the item, a set of candidate replacement items. The online system generates, based at least in part on one or more features of each candidate replacement item from the set of candidate replacement items, one or more features of the item, and replacement data for the user, a replacement score for each candidate replacement item that is indicative of a likelihood of conversion by the user of each candidate replacement item. The online system computes, using at least one of the attribute selection signal or information about each candidate replacement item, an attribute match score that is indicative of a number of the one or more attributes selected by the user present in each candidate replacement item. The online system selects, based at least in part on the replacement score for each candidate replacement item and the attribute match score for each candidate replacement item, a set of replacement items from the set of candidate replacement items. The online system generates, using the attribute selection signal and information about the set of replacement items, a second user interface signal. The online system sends, via the network, the second user interface signal to the device associated with the picker, wherein the sending the second user interface signal causes the device associated with the picker to display the second user interface with the one or more attributes and the set of replacement items.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates an example architectural flow diagram of using a machine-learning model to generate a user interface for attribute selection by a user of an online system, in accordance with one or more embodiments.

FIG. 3B illustrates an example architectural flow diagram of using a machine-learning model to generate a user interface for item replacement selection by a picker associated with an online system, in accordance with one or more embodiments.

FIG. 4A illustrates an example user interface of a device associated with a user of an online system for attribute selection, in accordance with one or more embodiments.

FIG. 4B illustrates an example user interface of a device associated with a picker for item replacement selection, in accordance with one or more embodiments.

FIG. 5A is a flowchart for a method of generating a user interface of an online system for attribute selection, in accordance with one or more embodiments.

FIG. 5B is a flowchart for a method of generating a user interface of an online system for item replacement selection, in accordance with one or more embodiments.

### DETAILED DESCRIPTION

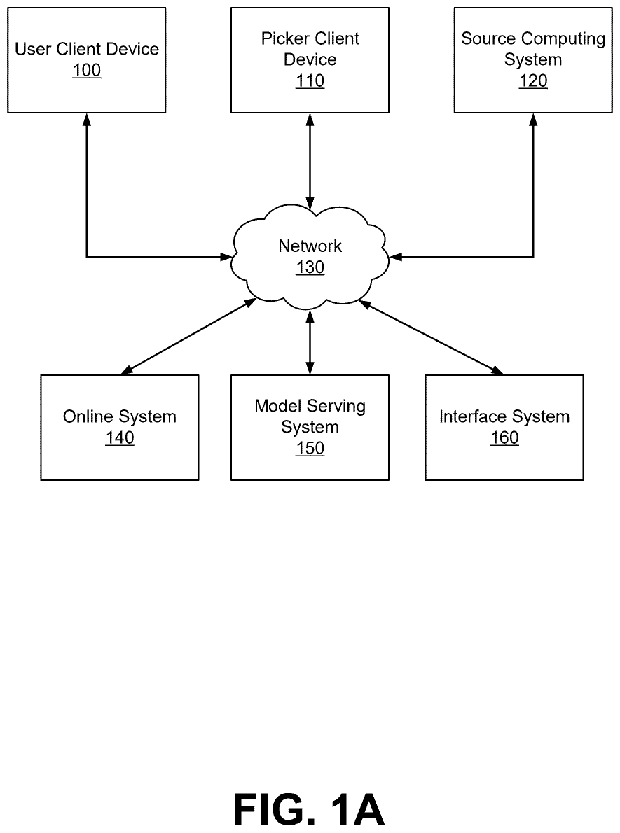

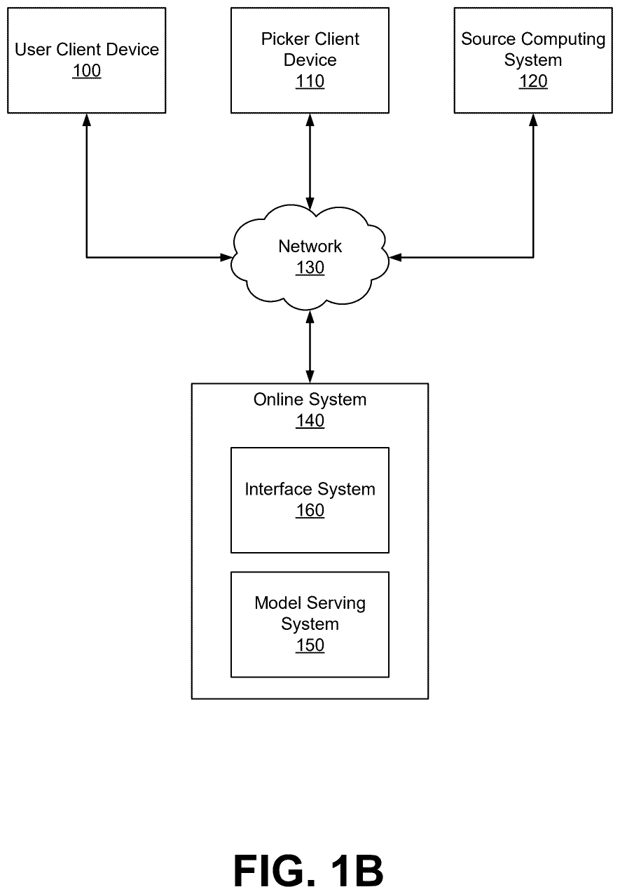

FIG. 1A illustrates an example system environment for an online system 140, in accordance with one or more embodiments. The system environment illustrated in FIG. 1A includes a user client device 100, a picker client device 110, a source computing system 120, a network 130, an online system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a time frame during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with an agent that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker (also referred to herein as a servicing agent, or agent) services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 fulfills an order for a user of the online system 140 by picking items at a source and delivering the items to the user. When an item is not found at the source, a picker attempts to find a suitable replacement item. To find acceptable replacements, the online system 140 allows the user, when placing an order, to specify attributes of an item that are important for that order (e.g., crackers that are “gluten free”). To provide an improved user interface that helps the user select an attribute for a given item, the online system 140 selects a subset of the item's attributes that are likely to be important and relevant to potential replacements. If the user selects one or more of the attributes, this information is communicated to the picker if the item is not found and hence needs to be replaced.

The model serving system 150 receives requests from the online system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

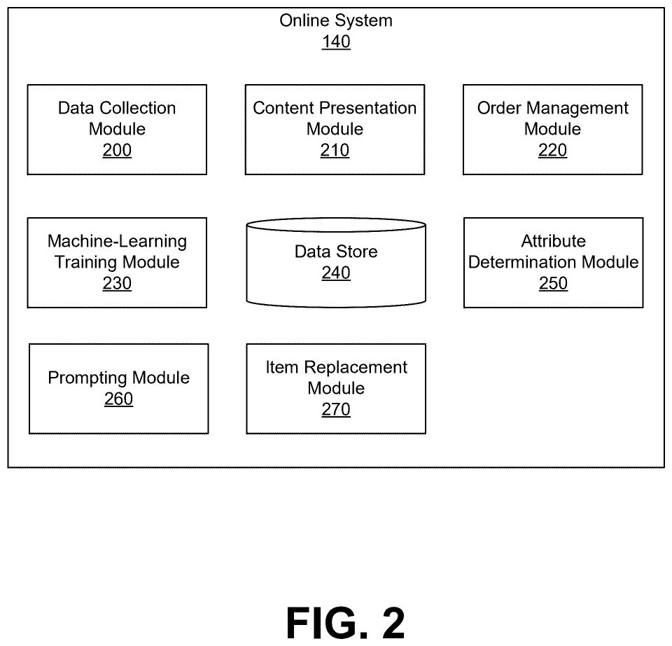

The online system 140 may prompt an LLM of the model serving system 150 to generate a set of attributes for an item in an order placed by a user of the online system 140. The online system 140 may prepare (e.g., via a prompting module 260 in FIG. 2) a prompt for input to the LLM. The prompt may include information about user's attribute preferences for replacement for the item. The LLM may generate a response to the prompt based on execution of the machine-learning model using the prompt. The response may include the set of attributes for the item. The online system 140 may import the response from the model serving system 150 and use the response to generate a user interface signal that is then sent to the user client device, wherein the sending the user interface signal causes the user client device to display a user interface with the set of attributes for the item for selection by the user.

In one or more embodiments, the task for the model serving system 150 is based on knowledge of the online system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, oftentimes, the amount of information in the external data exceeds prompt size limitations configured by the machine-learning language model. The interface system 160 can resolve prompt size limitations by generating a structured index of the data and offer data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In one or more embodiments, as illustrated in the example system environment in FIG. 1B, the model serving system 150 or the interface system 160 is managed and deployed by the entity managing the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, an attribute determination module 250, a prompting module 260, and an item replacement module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery time frame. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, time frames within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a time frame within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In one or more embodiments, the order management module 220 determines when to offer an order to a picker based on a delivery time frame requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested time frame. Thus, when the order management module 220 receives an order, the order management module 220 may delay offering the order to a picker if the requested time frame is far enough in the future (i.e., the picker may be offered the order at a later time and is still predicted to meet the requested time frame).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In one or more embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In one or more embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In one or more other embodiments, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer language model using training data stored in the data store 240. The machine-learning training module 230 may provide the transformer language model to the model serving system 150 for deployment.

The process flow may start when a user of the online system 140 selects an item to an order (or in some other context). After that, the attribute determination module 250 may get user's attribute preferences for replacement for the item, i.e., the attribute determination module 250 may determine a set of attributes to present to the user via a user interface of the user client device 100. The user may then utilize the user interface of the user client device 100 to select which one or more attributes from the set of attributes are the most important for the item.

The attribute determination module 250 may first retrieve a set of candidate attributes for a specific item. The attribute determination module 250 may retrieve a set of standard attributes, e.g., size, price, and brand. The attribute determination module 250 may further retrieve one or more additional attributes from a source catalog database (e.g., stored at the data store 240). In one or more embodiments, the prompting module 260 prompts a generative model (e.g., LLM of the model serving system 150) to generate the set of candidate attributes for the item. In such cases, the prompting module 260 may generate a prompt for input into the generative model, wherein the prompt may include information about the user's historic attribute preferences, e.g., as retrieved by the prompting module 260 from a user catalog database (e.g., stored at the data store 240).

In one or more embodiments, the prompting module 260 generates a prompt for input into the generative model, wherein the prompt includes item catalog data, taxonomy data (e.g., item type, item classification, etc.), and a request for the generative model to generate a response with a list of top attributes per each item category. In such cases, the prompting module 260 may retrieve the item catalog data and taxonomy data from the item catalog database. The prompting of the generative model with the item catalog data and taxonomy data may provide for high recall for cold start categories and items for which the online system 140 does not have enough data.

In one or more embodiments, the set of candidate attributes includes a combination of the standard attributes (or hard coding attributes) and dynamic attributes. The standard attributes are attributes that do not change from one item to another. Examples of the standard attributes are: “same brand”, “similar price”, “same size”. The dynamic attributes are attributes that dynamically change from one item to another. The dynamic attributes may be attributes associated with high precision and recall. Additionally, or alternatively, the dynamic attributes may be attributes assigned to an initial product, e.g., if the user is buying a gluten-free product, gluten free should be one of the top attributes shown at the user interface. Additionally, or alternatively, the dynamic attributes may be attributes that users care most about when selecting a replacement for each item taxonomy.

The attribute determination module 250 may generate a score for each candidate attribute in the set of candidate attributes. In one or more embodiments, the attribute determination module 250 scores each candidate attribute using historical statistics related to a replacement satisfaction difference, i.e., the user's satisfaction rate for replacing items with that candidate attribute and without that candidate attribute, or historical statistics data on certain attributes being important for a certain category of items. In one or more embodiments, to enable the online system 140 to be personalized for user's attributes, the attribute determination module 250 deploys a machine-learning model that is trained to generate a score for each candidate attribute.

The attribute determination module 250 may access an attribute determination model (e.g., machine-learning model) that is trained to generate a likelihood of an importance of each candidate attribute in the set of candidate attributes (or lift score) as part of a satisfaction rate for a given user of the online system 140. The attribute determination module 250 may deploy the attribute determination model to run a machine-learning algorithm to input signals to output a score for each candidate attribute in the set of candidate attributes, where the score is indicative of the likelihood of the importance of each candidate attribute in the user's satisfaction rate. The score may be a value between 0 and 1, where a lower value of the score is indicative of a lower likelihood of the importance of each candidate attribute in the user's satisfaction rate, and a higher value of the score is indicative of a higher likelihood of the importance of each candidate attribute in the user's satisfaction rate. The attribute determination model may be a classification machine-learning model, such as the eXtreme Gradient Boosting (XGBoost) machine-learning model. A set of parameters for the attribute determination model may be stored at one or more non-transitory computer-readable media of the attribute determination module 250. Alternatively, the set of parameters for the attribute determination model may be stored at one or more non-transitory computer-readable media of the data store 240.

The attribute determination model may leverage a variety of input signals to generate the score for each candidate attribute for replacing a specific item. In providing the input signals to the attribute determination model, the attribute determination module 250 may provide information about an incremental user's replacement satisfaction rate observed from that candidate attribute in historical replacements, the user's Gross Merchandise Value (GMV) for the item, a product count in an order, an attribute type (e.g., standard or dynamic), an anchor item and its attributes, a set of replacement suggestions available for that candidate attribute, some other data suitable for inferring the score for each candidate attribute, or some combination thereof. The attribute determination module 250 may retrieve the input signals from the user catalog database or an item catalog database (e.g., stored at the data store 240). Additionally, at least some of the input signals may be communicated in real time from the user client device 100 or the source computing system 120 via the network 130 to the online system 140 and the attribute determination module 250.

The machine-learning training module 230 may perform initial training of the attribute determination model using training data. The machine-learning training module 230 may generate the training data including information about past replacements performed by a collection of users of the online system 140 and information about a set of attributes related to each replacement item. The machine-learning training module 230 may retrieve the information about past replacements performed by a collection of users from the user catalog database. And the machine-learning training module 230 may retrieve information about a set of attributes related to each replacement item from the item catalog database. Each label included in the training data may include a set of identifiers for the set of attributes related to each replacement item and an identifier of that replacement item. The machine-learning training module 230 may train the attribute determination model using the training data to generate initial values for the set of parameters of the attribute determination model.

The attribute determination module 250 may use the score for each candidate attribute in the set of candidate attributes to select a subset of attributes for presentation to the user via a user interface of the user client device 100. In one or more embodiments, the attribute determination module 250 selects the subset of attributes as a predetermined number of candidate attributes from the set of candidate attributes that have the highest scores. In one or more other embodiments, the attribute determination module 250 selects the subset of attributes that correspond to those candidate attributes from the set of candidate attributes that have their scores above a threshold score. The attribute determination module 250 may use the score for each attribute from the selected subset of attributes to rank each attribute. The attribute determination module 250 may provide information about the selected subset of attributes and, optionally, information about a rank of each attribute, to the content presentation module 210.

The content presentation module 210 may use the information about the selected subset of candidate attributes and, optionally, the information about the rank of each attribute to generate a user interface signal. The content presentation module 210 may send, via the network 130, the user interface signal to the user client device 100. The user interface signal may cause the user client device 100 to display a user interface with the selected subset of attributes. The user interface signal may further cause the user client device 100 to display the user interface with the selected subset of attributes that are ranked in accordance with their scores. As a result, each attribute from the selected subset of attributes is shown at the user interface of the user client device 100, and optionally, at a particular position on the user interface. For example, an attribute with the highest score may be shown at a top position on the user interface, followed by another attribute having the second highest score, etc. The user may utilize one or more user interface elements to select one or more of the attributes shown at the user interface of the user client device 100. Information about the one or more attributes selected by the user (e.g., the user's explicit replacement attribute preferences) may be communicated from the user client device 100 via the network 130 to the online system 140 and the item replacement module 270.

The machine-learning training module 230 may collect feedback data with information about the user's response in relation to the subset of attributes suggested to the user, i.e., information about the user's explicit replacement attribute preferences. The feedback data may be recorded at the user client device 100 and communicated, via the network 130, to the online system 140 and the machine-learning training module 230. The feedback data may include information about whether the user selected each attribute that is suggested to the user via the user interface of the user client device 100. The machine-learning training module 230 may then re-train the attribute determination model by updating the set of parameters of the attribute determination model using the feedback data. By collecting feedback data with information about explicit replacement attribute preferences from various users, the attribute determination model may be re-trained and continuously improved over time.

When an item requested by the user is not found, the item replacement module 270 may initiate a process of finding a replacement item for the picker to obtain. The item replacement module 270 may use information about the missing item (e.g., taxonomy, brand, etc.) to retrieve, from the item catalog database, a set of candidate replacement items. The item replacement module 270 may then access an item replacement model (e.g., machine-learning model) that is trained to predict a likelihood of conversion by the user of each candidate replacement item from the set of candidate replacement items. The item replacement module 270 may deploy the item replacement model to run a machine-learning algorithm to input signals to output a replacement score for each candidate replacement item, where the replacement score is indicative of the likelihood of conversion by the user of each candidate replacement item when suggested to the user for replacing the missing item. The replacement score may be a value between 0 and 1, where a lower value of the replacement score is indicative of a lower likelihood of conversion by the user of each candidate replacement item, and a higher value of the replacement score is indicative of a higher likelihood of conversion by the user of each candidate replacement item. A set of parameters for the item replacement model may be stored at one or more non-transitory computer-readable media of the item replacement module 270. Alternatively, the set of parameters for the item replacement model may be stored at one or more non-transitory computer-readable media of the data store 240.

The item replacement model may leverage various input signals to generate the replacement score for each candidate replacement item. In providing the input signals to the item replacement model, the item replacement module 270 may provide taxonomy information about the missing item, taxonomy information about each candidate replacement item, user's historical replacement data, some other data, or some combination thereof. The item replacement module 270 may retrieve the input signals from the item catalog database or the user catalog database.

The item replacement module 270 may further compute an attribute match score for each candidate replacement item, which describes how many of the user's explicitly selected attributes each candidate replacement item has. Hence, all attributes explicitly selected by the user and all attributes present in each candidate replacement item are treated the same. In this manner, an incremental knowledge from dynamic attributes may be converted to a static score. The item replacement module 270 may thus compute the attribute match score as a ratio of a number of the user's explicitly selected attributes present in each candidate replacement item to a total number of attributes explicitly selected by the user for the missing item. For example, if a number of the user's explicitly selected attributes that are also present in a first candidate replacement item is 0, then the attribute match score for the first candidate replacement item is 0; and if a number of the user's explicitly selected attributes that are also present in a second candidate replacement item is the same as the total number of the user's explicitly selected attributes for the missing item, then the attribute match score for the second candidate replacement item is one.

Upon computing the attribute match score for each candidate replacement item, the item replacement module 270 may select a set of replacement items to show to the picker via a user interface of the picker client device 110. In one or more embodiments, the item replacement module 270 accesses a second item replacement model (e.g., machine-learning model) that is trained to predict a modified likelihood of conversion by the user of each candidate replacement item given the attribute match score for each candidate replacement item. The item replacement module 270 may deploy the second item replacement model to run a machine-learning algorithm to input signals to output a modified replacement score for each candidate replacement item, where the modified replacement score is indicative of the modified likelihood of conversion by the user of each candidate replacement item given the attribute match score for each candidate replacement item. The modified replacement score may be a value between 0 and 1, where a lower value of the modified replacement score is indicative of a lower likelihood of conversion by the user of each candidate replacement item, and a higher value of the modified replacement score is indicative of a higher likelihood of conversion by the user of each candidate replacement item. A set of parameters for the second item replacement model may be stored at one or more non-transitory computer-readable media of the item replacement module 270. Alternatively, the set of parameters for the second item replacement model may be stored at one or more non-transitory computer-readable media of the data store 240. The second item replacement model may be implemented as the deep learning model.

The second item replacement model may leverage various input signals to generate the modified replacement score for each candidate replacement item. In providing the input signals to the second item replacement model, the item replacement module 270 may provide the replacement score for each candidate replacement item generated by the item replacement model, the attribute match score for each candidate replacement item, a set of matching attributes that match the user's explicit selection and each candidate replacement item, a set of non-matching attributes representing attributes explicitly selected by the user but not present in each candidate replacement item, information about the user's historic approved replacements, a variance of each dynamic attribute (e.g., gluten free) for every source category, product embeddings, user's embeddings, user's pickiness with replacements; information about the user's affinity for the set of matching attributes and the set of non-matching attributes; a difference between a price of each candidate replacement item and a price of the missing item, a difference between a size of each candidate replacement item and a size of the missing item, some other information, or some combination thereof. The variance of each dynamic attribute may provide understanding of what attributes the user is more or less flexible with. The item replacement module 270 may retrieve at least some of the input signals for the second item replacement model from the item catalog database or the user catalog database. The item replacement module 270 may derive some of the input signals using information retrieved from the item catalog database or the user catalog database.

The machine-learning training module 230 may perform initial training of the second item replacement model using training data. The machine-learning training module 230 may generate the training data that include information about historical replacements for a collection of users, attributes associated with the historical replacements, attributes associated with historical missing items requested by the collection of users, some other information, or some combination thereof. The machine-learning training module 230 may retrieve the training data from the user catalog database or the item catalog database. Each label included in the training data may include an identifier of a replacement item converted by a user of the collection of users, a vector of embeddings for a set of attributes that are present in the replacement item, and a second vector of embeddings for a second set of attributes that are present in a missing item originally requested by that user. The machine-learning training module 230 may train the second item replacement model using the training data to generate initial values for the set of parameters of the second item replacement model.

The item replacement module 270 may use the modified replacement score for each candidate replacement item generated by the second item replacement model to re-rank the set of candidate replacement items. The item replacement module 270 may then select a set of replacement items for presentation to the picker that correspond to a predetermined number of candidate replacement items that have the highest modified replacement scores. Alternatively, the item replacement module 270 may select a set of replacement items for presentation to the picker that correspond to candidate replacement items having their modified replacement scores above a threshold replacement score. Hence, in such cases, the set of candidate replacement items may be re-ranked and those candidate replacement items that match the most user's explicitly selected attributes are prioritized for presentation to the picker. The item replacement module 270 may communicate, via the network 130 to the content presentation module 210, information about attributes explicitly selected by the user, information about the set of replacement items, and information about the modified replacement score for each replacement item in the set of replacement items. Some advantages of deploying the second item replacement model for generating modified replacement scores and re-ranking of candidate replacement items based on the modified replacement scores may be avoidance of decreased replacement coverage, as well as finding the right trade-offs between different attributes and blending the final ranking accordingly.

In one or more other embodiments, the item replacement module 270 filters the set of candidate replacement items using the attribute match score for each candidate replacement item to generate a set of replacement items for presentation to the picker. In such cases, the item replacement module 270 may generate the set of replacement items by filtering out one or more candidate replacement items having their attribute match scores below a threshold attribute match score. More specifically, the item replacement module 270 may generate the set of replacement items by filtering out one or more candidate replacement items that do not have at least one of the user's explicitly selected attributes. Then, the item replacement module 270 may re-rank remaining candidate replacement items, such that those candidate replacement items having the most user's explicitly selected attributes are ranked the highest. The item replacement module 270 may communicate, via the network 130 to the content presentation module 210, information about attributes explicitly selected by the user, information about the set of replacement items, and information about the modified replacement score for each replacement item in the set of replacement items. One advantage of the filtering approach is that the user's expectations are upheld as it is ensured that each replacement item shown to the picker meets at least one selected attribute explicitly selected by the user. However, in some cases, the filtering approach may risk removing highly relevant replacement items, may be highly dependent on accuracy of the item catalog database, and may have a decreased coverage of replacement items relative to the re-raking approach based on modified replacement scores generated by the second item replacement model.

In one or more other embodiments, the prompting module 260 may generate a prompt for input into a generative model (e.g., LLM of the model serving system 150) that includes the set of candidate replacement items and the attribute match score for each candidate replacement item from the set of candidate replacement items. The prompting module 260 may request the generative model to output, based on the prompt input into the generative model, a response with a set of replacement items for presentation to the picker. The prompting module 260 or the item replacement module 270 may communicate, via the network 130 to the content presentation module 210, information about attributes explicitly selected by the user, information about the set of replacement items, and information about the modified replacement score for each replacement item in the set of replacement items.

In one or more other embodiments, the user client device 100 may communicate, via the network 130, the user's explicit preferences for replacement items to the picker client device 110 for displaying at a user interface of the picker client device 110. The picker may then utilize information about the user's explicit preferences for replacement items displayed at the user interface of the picker client device 110 to make an appropriate replacement suggestion to the user.

The content presentation module 210 may use the information about attributes explicitly selected by the user, the information about the set of replacement items, and the information about the modified replacement score for each replacement item to generate a user interface signal. The content presentation module 210 may send, via the network 130, the user interface signal to the picker client device 110. The user interface signal may cause the picker client device 110 to display a user interface with the attributes explicitly selected by the user and information about the set of replacement items, where the replacement items are positioned at the user interface of the picker client device 110 according to their modified replacement scores. For example, a replacement item with the highest modified replacement score may be shown at the top position on the user interface, followed by another replacement item having the second highest modified replacement score, etc. In this manner, the replacement items may be ranked and presented on the user interface of the picker client device 110 in a particular ranking order that is based on the user's explicitly selected attributes. The picker may utilize a user interface element displayed at the user interface of the picker client device 110 to propose one of the suggested replacement items to the user for replacing the missing item. Alternatively, the picker may utilize another user interface element displayed at the user interface of the picker client device 110 to inform the user that no appropriate replacement for the missing item is found. This may occur when the picker realizes that none of the attributes explicitly selected by the user are present in the suggested replacement items.

The machine-learning training module 230 may collect feedback data with information about the user's response in relation to the replacement item suggested to the user by the picker. The feedback data may be recorded at the user client device 100 and communicated, via the network 130, to the online system 140 and the machine-learning training module 230. The feedback data may include information about whether the user accepted the suggested replacement item, chose another item that was not suggested for replacement, or just canceled the missing item. The machine-learning training module 230 may then re-train the second item replacement model by updating the set of parameters of the second item replacement model using the feedback data. By collecting feedback data with information about replacement responses from various users, the second item replacement model may be re-trained and continuously improved over time. The improvement of the second item replacement model may translate into maximizing a metric of user satisfaction on replacements. This metric may be tracked over time by tracking replacement approvals (e.g., a number of times users explicitly engage with “approve” user interface elements at user interfaces of the user client devices 100), by tracking order satisfactions (e.g., via chat responses from users), or by tracking appeasements due to “bad replacements” on items.

The user's explicit selection of attributes represents a strong signal for the user's general preferences. Hence, information about the user's explicit selection of attributes can be saved in the user catalog database and used to build the user's profile. Also, information about the user's explicit selection of attributes and information about a replacement item eventually selected by the user may be utilized by the online system 140 to understand the user's replacement tolerances and improve an inference of future replacement suggestions for the user. Additionally, or alternatively, once the user provides the same explicit attribute preferences over time, then the online system 140 may utilize these long-term user attribute preferences to filter all content displayed at the user interface of the user client device 100, including search results and ads. In this manner, the user's online experience may be personalized, such as the user interface of the online system 140 for this particular user may be provided in an “organic mode”, where only organic items are shown to the user. Additionally, or alternatively, information about the user's explicit selection of attributes or information about a replacement item eventually selected by the user may influence one or more other machine-learning models integrated into the online system 140, such as a machine-learning model trained for item searching, a machine-learning model trained for item discovering, or a machine-learning model trained for item ranking.

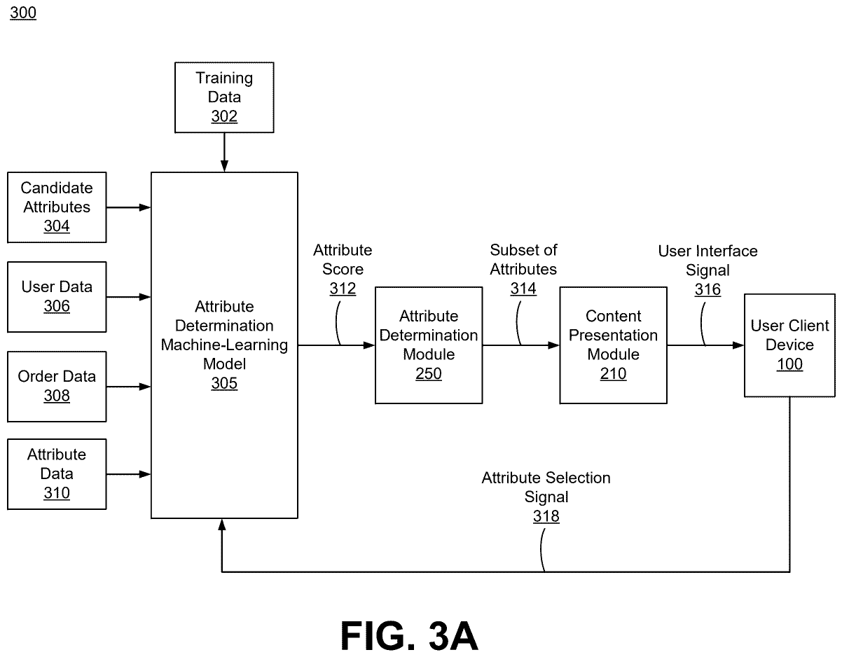

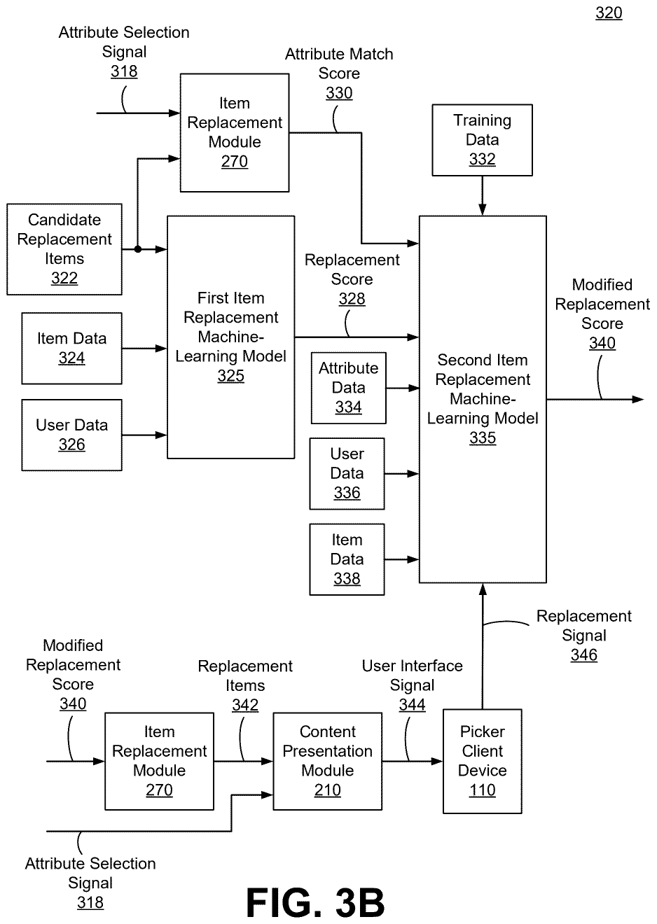

FIG. 3A illustrates an example architectural flow diagram 300 of using an attribute determination machine-learning model 305 to generate a user interface at the user client device 100 for attribute selection by a user of the online system 140, in accordance with one or more embodiments. The process flow may start when the order management module 220 receives, via the network 130 from the user client device 100, a selection signal indicating a user's selection of an item to an order. Responsive to the selection signal, the attribute determination module 250 may retrieve a set of candidate attributes 304 including one or more standard attributes and one or more dynamic attributes. The attribute determination module 250 may retrieve the set of candidate attributes 304 from the item catalog database or the source catalog database. Alternatively, the set of candidate attributes 304 may be generated by prompting a generative model. The attribute determination module 250 may pass the set of candidate attributes 304 to the attribute determination machine-learning model 305.

Prior to running a machine-learning algorithm of the attribute determination machine-learning model 305, the online system 140 may perform (e.g., via the machine-learning training module 230) initial training of the attribute determination machine-learning model 305 using training data 302. The training data 302 may be generated (e.g., via the machine-learning training module 230) by retrieving, from the user catalog database, information about past replacements performed by a collection of users, as well as by retrieving, from the item catalog database, information about a set of attributes related to each replacement item. The machine-learning training module 230 may then generate labels for the training data 302, each label including a set of identifiers for the set of attributes related to each replacement item and an identifier of that replacement item. The machine-learning training module 230 may train, using the training data 302 including the labels, the attribute determination machine-learning model 305 to generate a set of initial values for a set of parameters of the attribute determination machine-learning model 305. After the training process is completed, the online system 140 may provide a set of inputs to the attribute determination machine-learning model 305 (e.g., via the attribute determination module 250), such as user data 306, order data 308, or attribute data 310. Some additional inputs not shown in FIG. 3A suitable for inferring the user's attribute affinities may be further provided to the attribute determination machine-learning model 305.

In providing the user data 306 to the attribute determination machine-learning model 305, the attribute determination module 250 may provide information about an incremental user's replacement satisfaction rate observed in relation to each candidate attribute from the set of candidate attributes 304 associated with historical replacements, the user's GMV for the item selected to the order, some other user related data, or some combination thereof. The attribute determination module 250 may retrieve the user data 306 from the user catalog database.

In providing the order data 308 to the attribute determination machine-learning model 305, the attribute determination module 250 may provide information about the item count selected to the order, information about one or more other items selected to the order, some other order related data, or some combination thereof. The attribute determination module 250 may receive the order data 308 from the user client device 100 via the network 130.

In providing the attribute data 310 to the attribute determination machine-learning model 305, the attribute determination module 250 may provide information about an attribute type (e.g., standard or dynamic) for each candidate attribute from the set of candidate attributes 304, anchor attributes for the item selected to the order, information about one or more replacements available for each candidate attribute from the set of candidate attributes 304, some other attribute related data, or some combination thereof. The attribute determination module 250 may retrieve the attribute data 310 from the item catalog database.

The attribute determination machine-learning model 305 may apply, for each candidate attribute from the set of candidate attributes 304, the machine-learning algorithm to the user data 306, the order data 308, or the attribute data 310 to generate an attribute score 312, where each attribute score 312 (e.g., value between 0 and 1) is indicative of a likelihood of importance of each candidate attribute from the set of candidate attributes 304 in the user's satisfaction rate. The attribute determination machine-learning model 305 may pass attribute scores 312 for the set of candidate attributes 304 back to the attribute determination module 250.

The attribute determination module 250 may use the attribute scores 312 for the set of candidate attributes 304 to select a subset of attributes 314 for presentation to the user via a user interface of the user client device 100. The attribute determination module 250 may select the subset of attributes 314 as a predetermined number of candidate attributes from the set of candidate attributes 304 that have the highest attribute scores. Alternatively, the attribute determination module 250 may select the subset of attributes 314 that correspond to those candidate attributes from the set of candidate attributes 304 that have their attribute scores above a threshold score. The attribute determination module 250 may also use the attribute score 312 for each attribute from the subset of attributes 314 to rank the subset of attributes 314. The attribute determination module 250 may provide information about the subset of attributes 314 and a rank of each attribute from the subset of attributes 314 to the content presentation module 210.

The content presentation module 210 may generate, using the information about the subset of attributes 314 and the rank of each attribute from the subset of attributes 314, a user interface signal 316. The content presentation module 210 may send, via the network 130, the user interface signal 316 to the user client device 100. The user interface signal 316 may cause the user client device 100 to display a user interface with the selected subset of attributes 314 that may be ranked in accordance with the rank of each attribute. As a result, each attribute from the subset of attributes 314 may be shown at the user interface of the user client device 100 at a particular position on the user interface. The user may utilize one or more user interface elements to select one or more of the subset of attributes 314 shown at the user interface of the user client device 100. Information about the one or more attributes selected by the user (e.g., the user's explicit replacement attribute preferences) may be recorded at the user client device 100 as an attribute selection signal 318. The user client device 100 may communicate the attribute selection signal 318 to the online system 140 via the network 130.

The online system 140 and the machine-learning training module 230 may receive the attribute selection signal 318. The machine-learning training module 230 may utilize the attribute selection signal 318 to re-train the attribute determination machine-learning model 305. By utilizing attribute selection signals 318 provided by different users of the online system 140, the machine-learning training module 230 may update the set of parameters of the attribute determination machine-learning model 305 and continuously improve the machine-learning algorithm of the attribute determination machine-learning model 305.

FIG. 3B illustrates an example architectural flow diagram 320 of using a first item replacement machine-learning model 325 and a second item replacement machine-learning model 335 to generate a user interface of the picker client device 110 for item replacement selection by a picker, in accordance with one or more embodiments. The process of finding a replacement item for the picker to obtain may start when the item selected to order by the user is not found. The item replacement module 270 may use information about the item (e.g., taxonomy, brand, etc.) to retrieve, from the item catalog database, a set of candidate replacement items 322. The item replacement module 270 may pass the set of candidate replacement items 322 to the first item replacement machine-learning model 325. In addition to the set of candidate replacement items 322, the item replacement module 270 may provide item data 324 and/or user data 326 to the first item replacement machine-learning model 325.

In providing the item data 324 to the first item replacement machine-learning model 325, the item replacement module 270 may provide taxonomy information about the missing item, taxonomy information about each candidate replacement item from the set of candidate replacement items 322, some other item related data, or some combination thereof. The attribute determination module 250 may retrieve the item data 324 from the item catalog database. In providing the user data 326 to the first item replacement machine-learning model 325, the item replacement module 270 may provide user's historical replacement data, information about user's brand preferences, some other user related data, or some combination thereof. The item replacement module 270 may retrieve the user data 326 from the user catalog database.

The first item replacement machine-learning model 325 may apply, for each candidate replacement item from the set of candidate replacement items 322, the machine-learning algorithm to the item data 324 and/or the user data 326 to generate a replacement score 328 (e.g., value between 0 and 1) for each candidate replacement item 322 that is indicative of a likelihood of conversion by the user of each candidate replacement item 322 when suggested to the user for replacing the missing item. The first item replacement machine-learning model 325 may pass replacement scores 328 for the set of candidate replacement items 322 to the second item replacement machine-learning model 335.

The item replacement module 270 may compute an attribute match score 330 for each candidate replacement item 322 using the attribute selection signal 318 with information about attributes explicitly selected by the user for the missing item via the user interface of the user client device 100 and information about how many of the user's explicitly selected attributes each candidate replacement item 322 has. The item replacement module 270 may compute the attribute match score 330 as a ratio of a number of the user's explicitly selected attributes present in each candidate replacement item 322 to a total number of attributes explicitly selected by the user (e.g., information carried by the attribute selection signal 318). The item replacement module 270 may pass the attribute match score 330 for each candidate replacement item 322 to the second item replacement machine-learning model 335.

Prior to running a machine-learning algorithm of the second item replacement machine-learning model 335, the online system 140 may perform (e.g., via the machine-learning training module 230) initial training of the second item replacement machine-learning model 335 using training data 332. The training data 332 may be generated (e.g., via the machine-learning training module 230) by retrieving, from the user catalog database or the item catalog database, information about historical replacements for a collection of users, attributes associated with the historical replacements, and attributes associated with historical missing items requested by the collection of users. The machine-learning training module 230 may further generate labels for the training data 332, each label including an identifier of a replacement item converted by a user of the collection of users, a vector of embeddings for a set of attributes that are present in the replacement item, and a second vector of embeddings for a second set of attributes that are present in a missing item originally requested by that user. The machine-learning training module 230 may train, using the training data 332 including the labels, the second item replacement machine-learning model 335 to generate a set of initial values for a set of parameters of the second item replacement machine-learning model 335. After the training process is completed, in addition to the replacement score 328 for each candidate replacement item 322 and the attribute match score 330 for each candidate replacement item 322, the online system 140 may provide one or more other inputs to the second item replacement machine-learning model 335 (e.g., via the item replacement module 270), such as attribute data 334, user data 336, and/or item data 338. Some additional inputs not shown in FIG. 3B may be further provided to the second item replacement machine-learning model 335.

In providing the attribute data 334 to the second item replacement machine-learning model 335, the item replacement module 270 may provide a set of matching attributes that match the user's explicit selection and each candidate replacement item 322, a set of non-matching attributes representing attributes explicitly selected by the user but not present in each candidate replacement item 322, some other attribute related data, or some combination thereof. In providing the user data 336 to the second item replacement machine-learning model 335, the item replacement module 270 may provide information about the user's historic approved replacements, user's embeddings, information about user's pickiness with replacements, information about the user's affinity for the set of matching attributes and the set of non-matching attributes, some other user related data, or some combination thereof. The item replacement module 270 may retrieve some of the user data 336 from the user catalog database or derive at least a portion of the user data 336 from the set of candidate replacement items 322 and the attribute selection signal. In providing the item data 338 to the second item replacement machine-learning model 335, the item replacement module 270 may provide one or more embeddings for each candidate replacement item 322, a difference between a price of each candidate replacement item 322 and a price of the missing item, a difference between a size of each candidate replacement item 322 and a size of the missing item, some other item related data, or some combination thereof. The item replacement module 270 may retrieve the item data 338 from the item catalog database or may receive some of the item data 338 from the user client device 100 via the network 130.

The second item replacement machine-learning model 335 may apply, for each candidate replacement item 322, the machine-learning algorithm to the replacement score 328 for each candidate replacement item 322, the attribute match score for each candidate replacement item 322, the attribute data 334, the user data 336, or the item data 338 to generate a modified replacement score 340 (e.g., value between 0 and 1) for each candidate replacement item 322 that is indicative of a modified likelihood of conversion by the user of each candidate replacement item 322 given the attribute match score 330 for each candidate replacement item 322. The second item replacement machine-learning model 335 may pass modified replacement scores 340 for the set of candidate replacement items 322 back to the item replacement module 270.

The item replacement module 270 may use the modified replacement score 340 for each candidate replacement item 322 to re-rank the set of candidate replacement items 322. The item replacement module 270 may then select a set of replacement items 342 for presentation to the picker that correspond to a predetermined number of candidate replacement items 322 that have the highest modified replacement scores 340. Alternatively, the item replacement module 270 may select the set of replacement items 342 for presentation to the picker that correspond to candidate replacement items 322 having their modified replacement scores 340 above a threshold replacement score. The item replacement module 270 may communicate, via the network 130 to the content presentation module 210, the attribute selection signal 318 with information about the attributes explicitly selected by the user and the set of replacement items 342 re-ranked in accordance with their modified replacement scores 340.

The content presentation module 210 may generate a user interface signal 344 using the attribute selection signal 318 and the set of replacement items 342. The content presentation module 210 may send, via the network 130, the user interface signal 344 to the picker client device 110. The user interface signal may cause the picker client device 110 to display a user interface with the attributes explicitly selected by the user (i.e., the subset of attributes 314) and the set of replacement items 342 that are positioned at the user interface of the picker client device 110 according to their modified replacement scores 340. The picker may utilize a user interface element displayed at the user interface of the picker client device 110 to propose one of the replacement items 342 to the user for replacing the missing item. Alternatively, the picker may utilize another user interface element displayed at the user interface of the picker client device 110 to inform the user that no appropriate replacement for the missing item is found. Information about the replacement that is confirmed by the user (e.g., one of the replacement items 342 or no selection of any of the replacement items 342) may be recorded at the picker client device 110 as a replacement signal 346. The picker client device 110 may communicate the replacement signal 346 to the online system 140 via the network 130.

The online system 140 and the machine-learning training module 230 may receive the replacement signal 346. The machine-learning training module 230 may utilize the replacement signal 346 to re-train the second item replacement machine-learning model 335. By utilizing replacement signal 346 provided by various pickers in relation to replacements performed by different users of the online system 140, the machine-learning training module 230 may update the set of parameters of the second item replacement machine-learning model 335 and continuously improve the machine-learning algorithm of the second item replacement machine-learning model 335.

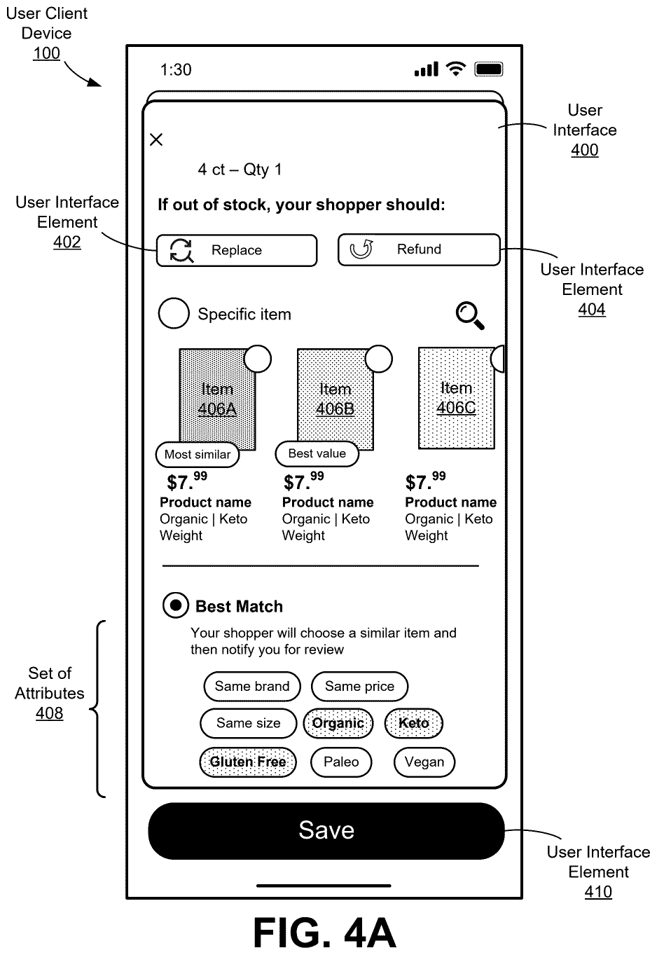

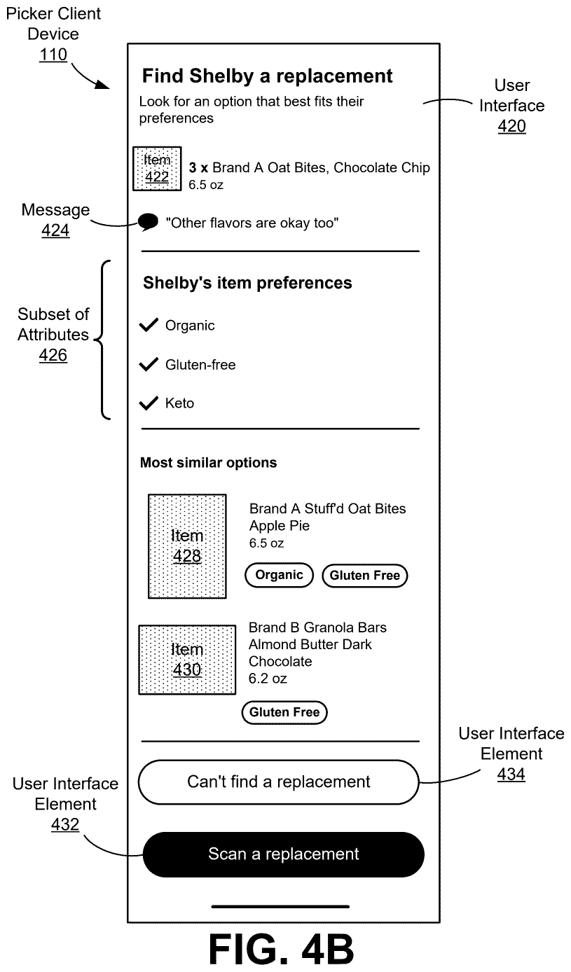

FIG. 4A illustrates an example user interface 400 of the user client device 100 for attribute selection, in accordance with one or more embodiments. The user interface 400 shows a user interface element 402 that the user can select to request a replacement if an item originally requested by the user is out of stock, as well as a user interface element 404 that the user can select to request a refund if an item originally requested by the user is out of stock. The user interface 400 can further display items 406A, 406B, 406C that the user can select as an explicit request for replacement if an item originally requested by the user is out of stock. Finally, the user interface 400 displays a set of attributes 408 as determined by the processes described in relation to FIG. 2 and FIG. 3A. For example, as shown in FIG. 4A, the set of attributes 408 includes standard attributes, such as “same brand”, “same price”, and “same size”. Additionally, the set of attributes 408 includes dynamic attributes, such as “organic”, “keto”, “gluten free”, “paleo”, and “vegan”. The user can utilize corresponding user interface elements of the user interface 400 to select one or more of the attributes 408, such as the dynamic attributes “organic”, “keto”, and “gluten free”. Once the user selects the desired attributes 408 and saves the selection via a user interface element 410, the user client device 100 records this information as a part of an attribute selection signal that is then communicated from the user client device 100 to the picker client device 110 via the network 130. The user client device 100 may further communicate, via the network 130, the attribute selection signal to the online system 140 and the machine-learning training module 230. The machine-learning training module 230 may re-train the attribute determination model using the attribute selection signal.

FIG. 4B illustrates an example user interface 420 of the picker client device 110 for item replacement selection, in accordance with one or more embodiments. The user interface 420 shows an item 422 that is out-of-stock, as well as a message 424 from the user in relation to a replacement preference. The user interface 420 further shows a subset of attributes 426 as explicitly selected by the user via the user interface 400 of the user client device 100. As shown in FIG. 4B, the subset of attributes 426 that were explicitly selected by the user includes the dynamic attributes “organic”, “gluten free”, and “keto”. The subset of attributes 426 may be ranked at the user interface 420 in accordance with their scores generated by the attribute determination module 250 or the attribute determination model as described in relation to FIG. 2 and FIG. 3A.

The user interface 420 further displays replacement items 428 and 430 determined using the process described in relation to FIG. 2 and FIG. 3B. The replacement items 428 and 430 may be displayed at the user interface 420 in accordance with their modified replacement scores. The replacement item 428 is displayed at the user interface 420 above the replacement item 430 because a modified replacement score for the replacement item 428 is greater than a modified replacement score for the replacement item 430. Alternatively, the replacement item 428 is displayed at the user interface 420 above the replacement item 430 because an attribute match score for the replacement item 428 is greater than an attribute match score for the replacement item 430. As shown in FIG. 4B, the replacement item 428 has two out of three attributes that were selected by the user-the attributes “organic” and “gluten-free”, and the attribute match score for the replacement item 428 is ⅔ or 0.667; and the replacement item 430 has only one out of three attributes that were selected by the user-the attribute “gluten-free”, and the attribute match score for the replacement item 430 is ⅓ or 0.333.

The picker can utilize a user interface element 432 to select and scan the replacement item 428 or the replacement item 430 for suggesting to the user. Alternatively, the picker can utilize a user interface element 434 to inform the user that an appropriate replacement item for the out-of-stock item 422 could not be found. Once the picker selects one of the replacement items 428, 430 or selects the user interface element 432 indicating that the appropriate replacement item could not be found, the picker client device 110 records this information as a part of a replacement selection signal that is then communicated from the picker client device 110 to the user client device 100 via the network 130. Once the user confirms the replacement selection suggested by the picker (or accepts that the appropriate replacement item could not be found), the replacement selection signal may be further communicated, via the network 130, to the online system 140 and the machine-learning training module 230. The machine-learning training module 230 may re-train the second item replacement model using the replacement selection signal.

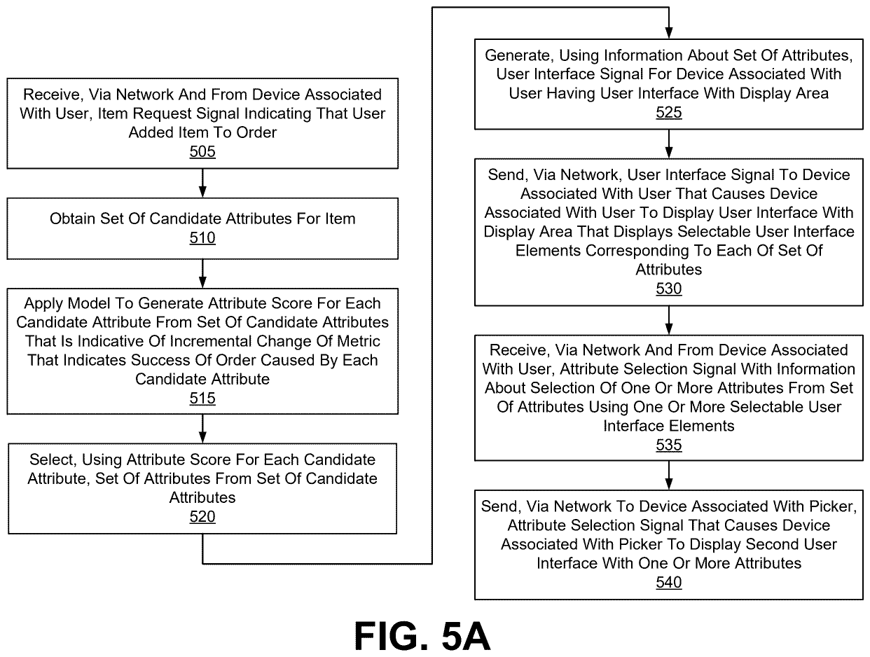

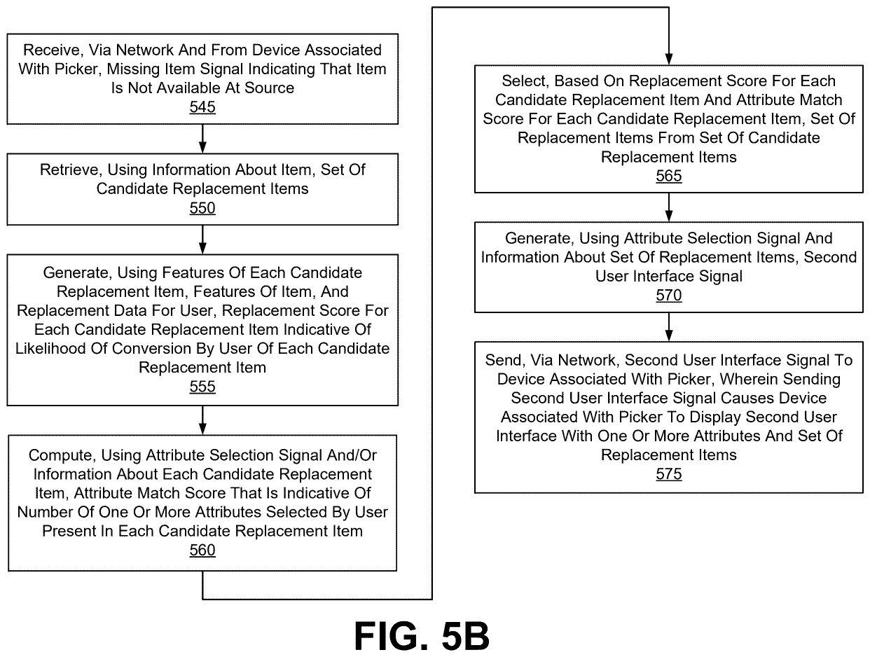

FIG. 5A is a flowchart for a method of generating a user interface of an online system for attribute selection, in accordance with one or more embodiments. Alternative embodiments may include more, fewer, or different steps from those illustrated in FIG. 5A, and the steps may be performed in a different order from that illustrated in FIG. 5A. These steps may be performed by an online system (e.g., the online system 140). Additionally, each of these steps may be performed automatically by the online system without human intervention.

The online system 140 receives 505 (e.g., at the order management module 220), via a network (e.g., the network 130) and from a device associated with a user of the online system 140 (e.g., the user client device 100), an item request signal indicating that the user added an item to an order. Responsive to receiving the item request signal, the online system 140 obtains 510 (e.g., via the attribute determination module 250) a set of candidate attributes for the item.

The online system 140 may retrieve (e.g., via the prompting module 260), from a database of the online system 140 (e.g., the data store 240), information about attribute preferences for the user. The online system 140 may generate (e.g., via the prompting module 260) a prompt for input into a generative model (e.g., LLM of the model serving system 150), the prompt including the information about attribute preferences for the user and information about one or more features of the item. The online system 140 may request (e.g., via the prompting module 260) the generative model to generate, based on the prompt input into the generative model, a response including the set of candidate attributes.

The online system 140 may retrieve (e.g., via the attribute determination module 250), from the database and using information about one or more features of the item, one or more dynamic candidate attributes. The online system 140 may combine (e.g., via the attribute determination module 250) one or more standard candidate attributes with the one or more dynamic candidate attributes to generate the set of candidate attributes.

The online system 140 applies 515 (e.g., via the attribute determination module 250) a model to generate an attribute score for each candidate attribute from the set of candidate attributes that is indicative of an incremental change of a metric that indicates a success of the order caused by each candidate attribute. The success of the order can be defined as whether the user indicated they were satisfied with a fulfillment of the order, whether the user rejected a suggesting replacement for a missing item, whether the user asked for an appeasement, or any of another set of outcomes.

In one or more embodiments, the online system 140 applies the model by applying (e.g., via the attribute determination module 250) a set of rules to information about a first satisfaction rate of the user for historical replacements having each candidate attribute and information about a second satisfaction rate of the user for historical replacements without having each candidate attribute to generate the attribute score for each candidate attribute.

In one or more other embodiments, the online system 140 applies the model by applying (e.g., via the attribute determination module 250) an attribute determination machine-learning model to information about an incremental replacement satisfaction caused by each candidate attribute from the set of candidate attributes in historical replacements, information about a type of each candidate attribute, and information about a set of items associated with each candidate attribute to generate the attribute score for each candidate attribute.

The online system 140 may retrieve (e.g., via the machine-learning training module 230), from the database, information about past replacements performed by a collection of users of the online system 140. The online system 140 may further retrieve (e.g., via the machine-learning training module 230), from the database, information about a set of attributes related to each replacement item selected by a corresponding user of the collection of users. The online system 140 may generate a plurality of labels (e.g., via the machine-learning training module 230), each of the plurality of labels including a set of identifiers for the set of attributes related to each replacement item and an identifier of each replacement item. The online system 140 may train (e.g., via the machine-learning training module 230), using training data including the plurality of labels, the attribute determination machine-learning model to generate a set of initial values for a set of parameters of the attribute determination machine-learning model.

The online system 140 selects 520 (e.g., via the attribute determination module 250), using the attribute score for each candidate attribute, a set of attributes from the set of candidate attributes. The online system 140 generates 525 (e.g., via the content presentation module 210), using information about the set of attributes, a first user interface signal for the device associated with the user having a first user interface with a display area (e.g., limited display area), wherein the generating comprises displaying selectable user interface elements within the display area corresponding to each of the set of attributes. The online system 140 sends 530 (e.g., via the content presentation module 210), via the network, the first user interface signal to the device associated with the user, wherein the sending the first user interface signal causes the device associated with the user to display the first user interface with the display area that displays the selectable user interface elements corresponding to each of the set of attributes.

The online system 140 receives 535 (e.g., at the order management module 220), via the network and from the device associated with the user, an attribute selection signal with information about a selection of one or more attributes from the set of attributes using one or more of the selectable user interface elements. The online system 140 sends 540 (e.g., via the content presentation module 210), via the network to a device associated with a picker (e.g., the picker client device 110), the attribute selection signal, wherein the sending the attribute selection signal causes the device associated with the picker to display a second user interface with the one or more attributes.

FIG. 5B is a flowchart for a method of generating a user interface of an online system for item replacement selection, in accordance with one or more embodiments. Alternative embodiments may include more, fewer, or different steps from those illustrated in FIG. 5B, and the steps may be performed in a different order from that illustrated in FIG. 5B. These steps may be performed by an online system (e.g., the online system 140). Each of these steps in FIG. 5B may be performed after the steps of the method of FIG. 5A. Additionally, each of these steps in FIG. 5B may be performed automatically by the online system without human intervention.

The online system 140 receives 545 (at the order management module 220), via the network and from a device associated with a picker (e.g., the picker client device 110), a missing item signal indicating that the item is not available at a source. Responsive to receiving the missing item signal, the online system 140 retrieves 550 (e.g., via the item replacement module 270), using information about the item, a set of candidate replacement items.

The online system 140 generates 555 (e.g., via the item replacement module 270), based at least in part on one or more features of each candidate replacement item from the set of candidate replacement items, one or more features of the item, and replacement data for the user, a replacement score for each candidate replacement item that is indicative of a likelihood of conversion by the user of each candidate replacement item. The online system 140 may apply an item replacement machine-learning model (e.g., via the item replacement module 270) to the one or more features of each candidate replacement item from the set of candidate replacement items, the one or more features of the item, and the replacement data for the user to generate the replacement score for each candidate replacement item.

The online system 140 computes 560 (e.g., via the item replacement module 270), using at least one of the attribute selection signal or information about each candidate replacement item, an attribute match score that is indicative of a number of the one or more attributes selected by the user present in each candidate replacement item. The online system 140 selects 565 (e.g., via the item replacement module 270), based at least in part on the replacement score for each candidate replacement item and the attribute match score for each candidate replacement item, a set of replacement items from the set of candidate replacement items.

In one or more embodiments, the online system 140 filters (e.g., via the item replacement module 270), using the attribute match score for each candidate replacement item, one or more candidate replacement items from the set of candidate replacement items to generate the set of replacement items. In one or more other embodiments, the online system 140 applies an item replacement machine-learning model (e.g., via the item replacement module 270) to the replacement score for each candidate replacement item, the attribute match score for each candidate replacement item, a vector of embeddings for the user, and a vector of embeddings for each candidate replacement item to generate a modified replacement score for each candidate replacement item representing a modified value of the replacement score for each candidate replacement item. In such cases, the online system 140 may select (e.g., via the item replacement module 270), using the modified replacement score for each candidate replacement item, the set of replacement items from the set of candidate replacement items.

In one or more other embodiments, the online system 140 generates (e.g., via the prompting module 260) a prompt for input into a generative model (e.g., LLM of the model serving system 150), the prompt including the set of candidate replacement items and the attribute match score for each candidate replacement item. In such cases, the online system 140 may request (e.g., via the prompting module 260) the generative model to generate, based on the prompt input into the generative model, a response including the set of replacement items.

The online system 140 may rank (e.g., via the item replacement module 270), using the modified replacement score for each candidate replacement item, the set of candidate replacement items to generate a ranked list of candidate replacement items. The online system 140 may then select (e.g., via the item replacement module 270) a predetermined number of replacement items from the ranked list of candidate replacement items (e.g., the predetermined number of highest ranked candidate replacement items) to generate the set of replacement items.

The online system 140 generates 570 (e.g., via the content presentation module 210), using the attribute selection signal and information about the set of replacement items, a second user interface signal. The online system 140 sends 575 (e.g., via the content presentation module 210), via the network, the second user interface signal to the device associated with the picker, wherein the sending the second user interface signal causes the device associated with the picker to display the second user interface with the one or more attributes and the set of replacement items.

The online system 140 may generate (e.g., via the content presentation module 210) the second user interface signal further based on the modified replacement score for each replacement item from the set of replacement items. The online system 140 may then send the second user interface signal to the device associated with the picker that further causes the device associated with the picker to display the second user interface with the set of replacement items ranked at the second user interface in accordance with the modified replacement score for each replacement item from the set of replacement items.

The online system 140 may retrieve (e.g., via the machine-learning training module 230), from the database, information about historical replacements for a collection of users of the online system 140, attributes associated with the historical replacements, and attributes associated with historical missing items requested by the collection of users. The online system 140 may generate (e.g., via the machine-learning training module 230) a plurality of labels, each of the plurality of labels including an identifier of a replacement item converted by a user of the collection of users, a vector of embeddings for a set of attributes that are present in the replacement item, and a second vector of embeddings for a second set of attributes that are present in a missing item originally requested by the user of the collection of users. The online system 140 may train (e.g., via the machine-learning training module 230), using training data including the plurality of labels, the item replacement machine-learning model to generate a set of initial values for a set of parameters of the item replacement machine-learning model.

The online system 140 may receive (e.g., via the order management module 220), via the network and from the device associated with the picker, a replacement signal including information about a selection by the user of any replacement item from the set of replacement items. The online system 140 may re-train the item replacement machine-learning model by updating (e.g., via the machine-learning training module 230), using the replacement signal, a set of parameters of the item replacement machine-learning model.

Embodiments of the present disclosure are directed to the online system 140 that uses machine-learning models to generate adaptive and personalized user interfaces of the online system 140 for attribute selection and item replacement selection. The online system 140 may utilize a machine-learning model to determine attributes of an item for presentation to the user so that that the user can explicitly select their preferred replacement attributes in case the item is not available at a source, e.g., as established by the picker at the source. The online system 140 may then apply a novel replacement algorithm to rank, based on user-selected attributes, replacement suggestions for displaying at a user interface of the picker client device 110. The processes of the online system 140 may be further utilized to collect data from various users and use the collected data across different surfaces of the online system 140, such as a discover surface, search surface, item ranking surface, etc.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network and from a device associated with a user of an online system, an item request signal indicating that the user added an item to an order;
responsive to receiving the item request signal, obtaining a set of candidate attributes for the item;
applying a model to generate an attribute score for each candidate attribute from the set of candidate attributes that is indicative of an incremental change of a metric that indicates a success of the order caused by each candidate attribute;
selecting, using the attribute score for each candidate attribute, a set of attributes from the set of candidate attributes;
generating, using information about the set of attributes, a first user interface signal for the device associated with the user having a first user interface with a display area, wherein the generating comprises displaying selectable user interface elements within the display area corresponding to each of the set of attributes;
sending, via the network, the first user interface signal to the device associated with the user, wherein the sending the first user interface signal causes the device associated with the user to display the first user interface with the display area that displays the selectable user interface elements corresponding to each of the set of attributes;
receiving, via the network and from the device associated with the user, an attribute selection signal with information about a selection of one or more attributes from the set of attributes using one or more of the selectable user interface elements; and
sending, via the network to a device associated with a picker, the attribute selection signal, wherein the sending the attribute selection signal causes the device associated with the picker to display a second user interface with the one or more attributes.

2. The method of claim 1, wherein applying the model comprises:
applying an attribute determination machine-learning model to information about an incremental replacement satisfaction caused by each candidate attribute from the set of candidate attributes in historical replacements, information about a type of each candidate attribute, and information about a set of items associated with each candidate attribute to generate the attribute score for each candidate attribute.

3. The method of claim 2, further comprising:
retrieving, from a database of the online system, information about past replacements performed by a collection of users of the online system;
retrieving, from the database, information about a set of attributes related to each replacement item selected by a corresponding user of the collection of users;
generating a plurality of labels, each of the plurality of labels including a set of identifiers for the set of attributes related to each replacement item and an identifier of each replacement item; and
training, using training data including the plurality of labels, the attribute determination machine-learning model to generate a set of initial values for a set of parameters of the attribute determination machine-learning model.

4. The method of claim 1, wherein applying the model comprises:
applying a set of rules to information about a first historical replacement satisfaction rate of the user with each candidate attribute and information about a second historical replacement satisfaction rate of the user without each candidate attribute to generate the attribute score for each candidate attribute.

5. The method of claim 1, wherein obtaining the set of candidate attributes comprises:
retrieving, from a database of the online system, information about attribute preferences for the user;
generating a prompt for input into a generative model, the prompt including the information about attribute preferences for the user and information about one or more features of the item; and
requesting the generative model to generate, based on the prompt input into the generative model, a response including the set of candidate attributes.

6. The method of claim 1, wherein obtaining the set of candidate attributes comprises:
retrieving, from a database of the online system and using information about one or more features of the item, one or more dynamic candidate attributes; and
combining one or more standard candidate attributes with the one or more dynamic candidate attributes to generate the set of candidate attributes.

7. The method of claim 1, further comprising:
receiving, via the network and from the device associated with the picker, a missing item signal indicating that the item is not available at a source;
responsive to receiving the missing item signal, retrieving, using information about the item, a set of candidate replacement items;
generating, based at least in part on one or more features of each candidate replacement item from the set of candidate replacement items, one or more features of the item, and replacement data for the user, a replacement score for each candidate replacement item that is indicative of a likelihood of conversion by the user of each candidate replacement item;
computing, using at least one of the attribute selection signal or information about each candidate replacement item, an attribute match score that is indicative of a number of the one or more attributes selected by the user present in each candidate replacement item;
selecting, based at least in part on the replacement score for each candidate replacement item and the attribute match score for each candidate replacement item, a set of replacement items from the set of candidate replacement items;
generating, using the attribute selection signal and information about the set of replacement items, a second user interface signal; and
sending, via the network, the second user interface signal to the device associated with the picker, wherein the sending the second user interface signal causes the device associated with the picker to display the second user interface with the one or more attributes and the set of replacement items.

8. The method of claim 7, wherein generating the replacement score for each candidate replacement item comprises:
applying an item replacement machine-learning model to the one or more features of each candidate replacement item from the set of candidate replacement items, the one or more features of the item, and the replacement data for the user to generate the replacement score for each candidate replacement item.

9. The method of claim 7, wherein selecting the set of replacement items comprises:
filtering, using the attribute match score for each candidate replacement item, one or more candidate replacement items from the set of candidate replacement items to generate the set of replacement items.

10. The method of claim 7, wherein selecting the set of replacement items comprises:
applying an item replacement machine-learning model to the replacement score for each candidate replacement item, the attribute match score for each candidate replacement item, a vector of embeddings for the user, and a vector of embeddings for each candidate replacement item to generate a modified replacement score for each candidate replacement item representing a modified value of the replacement score for each candidate replacement item; and
selecting, using the modified replacement score for each candidate replacement item, the set of replacement items from the set of candidate replacement items.

11. The method of claim 10, wherein selecting the set of replacement items further comprises:
ranking, using the modified replacement score for each candidate replacement item, the set of candidate replacement items to generate a ranked list of candidate replacement items; and
selecting a predetermined number of replacement items from the ranked list of candidate replacement items to generate the set of replacement items.

12. The method of claim 10, wherein:
generating the second user interface signal comprises generating the second user interface signal further based on the modified replacement score for each replacement item from the set of replacement items; and
sending the second user interface signal to the device associated with the picker further causes the device associated with the picker to display the second user interface with the set of replacement items ranked at the second user interface in accordance with the modified replacement score for each replacement item from the set of replacement items.

13. The method of claim 10, further comprising:
retrieving, from a database of the online system, information about historical replacements for a collection of users of the online system, attributes associated with the historical replacements, and attributes associated with historical missing items requested by the collection of users;
generating a plurality of labels, each of the plurality of labels including an identifier of a replacement item converted by a user of the collection of users, a vector of embeddings for a set of attributes that are present in the replacement item, and a second vector of embeddings for a second set of attributes that are present in a missing item originally requested by the user of the collection of users; and
training, using training data including the plurality of labels, the item replacement machine-learning model to generate a set of initial values for a set of parameters of the item replacement machine-learning model.

14. The method of claim 10, further comprising:
receiving, via the network and from the device associated with the picker, a replacement signal including information about a selection by the user of any replacement item from the set of replacement items; and
re-training the item replacement machine-learning model by updating, using the replacement signal, a set of parameters of the item replacement machine-learning model.

15. The method of claim 10, wherein selecting the set of replacement items comprises:
generating a prompt for input into a generative model, the prompt including the set of candidate replacement items and the attribute match score for each candidate replacement item; and
requesting the generative model to generate, based on the prompt input into the generative model, a response including the set of replacement items.

16. A computer program product comprising a non-transitory computer readable storage medium having instructions encoded thereon that, when executed by a processor, cause the processor to perform steps comprising:
receiving, via a network and from a device associated with a user of an online system, an item request signal indicating that the user added an item to an order;
responsive to receiving the item request signal, obtaining a set of candidate attributes for the item;
applying a model to generate an attribute score for each candidate attribute from the set of candidate attributes that is indicative of an incremental change of a metric that indicates a success of the order caused by each candidate attribute;
selecting, using the attribute score for each candidate attribute, a set of attributes from the set of candidate attributes;
generating, using information about the set of attributes, a first user interface signal for the device associated with the user having a first user interface with a display area, wherein the generating comprises displaying selectable user interface elements within the display area corresponding to each of the set of attributes;
sending, via the network, the first user interface signal to the device associated with the user, wherein the sending the first user interface signal causes the device associated with the user to display the first user interface with the display area that displays the selectable user interface elements corresponding to each of the set of attributes;
receiving, via the network and from the device associated with the user, an attribute selection signal with information about a selection of one or more attributes from the set of attributes using one or more of the selectable user interface elements; and
sending, via the network to a device associated with a picker, the attribute selection signal, wherein the sending the attribute selection signal causes the device associated with the picker to display a second user interface with the one or more attributes.

17. The computer program product of claim 16, wherein the instructions further cause the processor to perform steps comprising:
applying the model by applying an attribute determination machine-learning model to information about an incremental replacement satisfaction caused by each candidate attribute from the set of candidate attributes in historical replacements, information about a type of each candidate attribute, and information about a set of items associated with each candidate attribute to generate the attribute score for each candidate attribute.

18. The computer program product of claim 16, wherein the instructions further cause the processor to perform steps comprising:
receiving, via the network and from the device associated with the picker, a missing item signal indicating that the item is not available at a source;
responsive to receiving the missing item signal, retrieving, using information about the item, a set of candidate replacement items;
generating, based at least in part on one or more features of each candidate replacement item from the set of candidate replacement items, one or more features of the item, and replacement data for the user, a replacement score for each candidate replacement item that is indicative of a likelihood of conversion by the user of each candidate replacement item;
computing, using at least one of the attribute selection signal or information about each candidate replacement item, an attribute match score that is indicative of a number of the one or more attributes selected by the user present in each candidate replacement item;
selecting, based at least in part on the replacement score for each candidate replacement item and the attribute match score for each candidate replacement item, a set of replacement items from the set of candidate replacement items;
generating, using the attribute selection signal and information about the set of replacement items, a second user interface signal; and
sending, via the network, the second user interface signal to the device associated with the picker, wherein the sending the second user interface signal causes the device associated with the picker to display the second user interface with the one or more attributes and the set of replacement items.

19. The computer program product of claim 18, wherein the instructions further cause the processor to perform steps comprising:
applying an item replacement machine-learning model to the replacement score for each candidate replacement item, the attribute match score for each candidate replacement item, a vector of embeddings for the user, and a vector of embeddings for each candidate replacement item to generate a modified replacement score for each candidate replacement item representing a modified value of the replacement score for each candidate replacement item; and
selecting, using the modified replacement score for each candidate replacement item, the set of replacement items from the set of candidate replacement items.

20. A computer system comprising:
a processor; and
a non-transitory computer-readable storage medium having instructions that, when executed by the processor, cause the computer system to perform steps comprising:
receiving, via a network and from a device associated with a user of an online system, an item request signal indicating that the user added an item to an order;
responsive to receiving the item request signal, obtaining a set of candidate attributes for the item;
applying a model to generate an attribute score for each candidate attribute from the set of candidate attributes that is indicative of an incremental change of a metric that indicates a success of the order caused by each candidate attribute;
selecting, using the attribute score for each candidate attribute, a set of attributes from the set of candidate attributes;
generating, using information about the set of attributes, a first user interface signal for the device associated with the user having a first user interface with a display area, wherein the generating comprises displaying selectable user interface elements within the display area corresponding to each of the set of attributes;
sending, via the network, the first user interface signal to the device associated with the user, wherein the sending the first user interface signal causes the device associated with the user to display the first user interface with the display area that displays the selectable user interface elements corresponding to each of the set of attributes;
receiving, via the network and from the device associated with the user, an attribute selection signal with information about a selection of one or more attributes from the set of attributes using one or more of the selectable user interface elements; and
sending, via the network to a device associated with a picker, the attribute selection signal, wherein the sending the attribute selection signal causes the device associated with the picker to display a second user interface with the one or more attributes.
